(19) United States
(12) Patent Application Publication
(10) Pub. No.: US 2022/0381114 A1
(43) Pub. Date: Dec. 1, 2022

(54) DEGRADABLE DOWNHOLE DISK

(71) Applicant: Saudi Arabian Oil Company, Dhahran (SA)

(72) Inventors: Abdulrahman Al Ahmari, Dhahran (SA); Mohammed Al Dabbous, Qatif (SA)

(73) Assignee: Saudi Arabian Oil Company, Dhahran (SA)

(21) Appl. No.: 17/331,076

(22) Filed: May 26, 2021

(51) Int. Cl. E21B 34/06; C09K 8/516

(52) U.S. Cl. CPC E21B 34/063; C09K 8/516; E21B 2200/08

(57) ABSTRACT

Methods and systems are provided for breaching a disk installed in a wellbore during oil and gas well completion and production activities. More specifically, the disclosure relates to installing and breaching a degradable disk installed in a wellbore. The degradable disk can maintain pressure within the wellbore during a wellbore procedure, such as packer installation. The degradable disk contains a nanocomposite material. The nanocomposite material includes a polymer binder and cellulose nano-fibers.

### FIELD

This disclosure relates to systems and methods for downhole tool removal. More specifically, this disclosure relates to a downhole disk that degrades over time after installation.

### BACKGROUND

During hydrocarbon well drilling and completion activities, production casing and production tubing is installed in a wellbore. Prior to production packer installation, ceramic disks are installed in the wellbore to maintain pressure and isolate the production tubing for wellbore operations. Once production packers are installed in the production casing, the ceramic disk is broken so that well flowback operations can begin.

Ceramic disks are generally ruptured with milling tools directed downhole with coiled tubing. Milling tools are drill-like tools that mechanically destroy the disk. Other ways of rupturing the ceramic disks include dropping go-devils or other tools in the wellbore. The conventional methods of milling or dropping tools results in the use of heavy equipment, takes substantial time and energy, and results in debris formation in the wellbore. The conventional methods of milling or dropping tools can also result in complications related to coil tubing getting locked-up (or stuck) within a wellbore, or breakage of heavy equipment. Additionally, it can take substantial time and energy to lower tools downhole, and other downhole operations may not be able to be performed downhole when the milling is being performed, or when the milling or other tools are lowered downhole.

Due to the long tool transit time downhole and due to the risk of damage or lock-up from lowering and raising downhole tools through the wellbore, avoiding tools runs downhole is advantageous. Therefore, additional methods of rupturing ceramic disks and performing well stimulation downhole are desired, including methods and systems that avoid additional tool usage downhole.

### SUMMARY

The disclosure relates to systems and methods for removing the functionality of a degradable disk installed in a wellbore during oil and gas well completion and production activities. The degradable disks are installed in a wellbore during wellbore operations. The wellbore operations can include packer installation, wellbore isolation sub installation, logging operations, or other well completion or production activities. The degradable disks can be installed in wellbore nipples, landing nipples, sealing sections of wellbore production piping, wellbore subs, or other sections of the production piping or casing of the wellbore, including screwing a threaded disk directly into producing piping or casing.

More specifically, the disclosure relates to breaching a degradable disk by allowing the disk to degrade downhole until structural failure. Once breached, the degradable disk can no longer hold pressure in the wellbore. The degradable disk is made of a nanocomposite material, which includes a polymer binder and cellulose nano-fibers.

Therefore, disclosed herein is a method of preparing a wellbore for production by installing a degradable disk in the wellbore and subsequently breaching the degradable disk. The degradable disk is operable to maintain pressure within the wellbore during a wellbore procedure. The method includes the step of exposing the degradable disk to a wellbore environment within the wellbore over an extended period of time, where the wellbore environment comprises a solvent. The solvent can be water. The method also includes the step of allowing the degradable disk to degrade so that the degradable disk is unable to hold pressure within the wellbore resulting in a breach. The degradable disk includes a nanocomposite material, and the nanocomposite material includes a polymer binder and cellulose nano-fibers.

In some embodiments, the degradable disk can withstand a wellbore pressure of 30,000 psi. The breach occurs at least 48 hours past installation of the degradable disk. In some embodiments, the extended period of time the degradable disk degrades within the wellbore is in the range of 16 to 26 days. The breach of the degradable disk occurs in the absence of intervention.

Further disclosed is a system for preparing a wellbore for production by installing a degradable disk in the wellbore and subsequently breaching the degradable disk. The system includes the wellbore extending through the hydrocarbon reservoir, and the degradable disk. The degradable disk is operable to maintain pressure during the wellbore procedure for a period of time. The degradable disk includes the nanocomposite material. The nanocomposite material includes the polymer binder and the cellulose nano-fibers. The degradable disk degrades over the extended period of time within the wellbore, and the degradation results in a breach of the degradable disk. In some embodiments, the extended period of time is in the range of 16 to 26 days. The degradable disk can withstand a wellbore pressure of 30,000 psi.

Further disclosed is a degradable downhole article for use in preparing a wellbore for production. The degradable downhole article includes a flat circular disk, where the disk has a flat top and a flat bottom. The flat top and the flat bottom are positioned parallel and directly opposite one another. The degradable downhole article also includes a flat edge abutted perpendicular to both the flat top and the flat bottom. The flat circular disk is one solid piece and exists in the absence of any open cavities. The flat circular disk is operable to be installed within a production tubing of a wellbore such that the flat circular disk tightly abuts an inner wall of the production tubing generating a seal, and operable to hold pressure within the wellbore. The flat circular disk includes the nanocomposite material. The nanocomposite material includes the polymer binder and the cellulose nano-fibers. The nanocomposite material is operable to degrade over an extended period of time so that at the end of the extended period of time, the flat circular disk is no longer able to hold pressure within the wellbore and experiences a breach.

In some embodiments, the extended period of time is in the range of 16 to 26 days. The degradable downhole article can withstand a wellbore pressure of 30,000 psi.

### BRIEF DESCRIPTION OF THE DRAWINGS

These and other features, aspects, and advantages of the present disclosure will become better understood with regard to the following descriptions, claims, and accompanying drawings. It is to be noted, however, that the drawings illustrate only several embodiments of the disclosure and are therefore not to be considered limiting of the scope as it can admit to other equally effective embodiments.

FIG. 1A is a schematic of a vertical wellbore portion, according to an embodiment.

FIG. 1B is a schematic of a horizontal wellbore portion, according to an embodiment.

FIG. 2 is a depiction of a degradable disk, according to an embodiment.

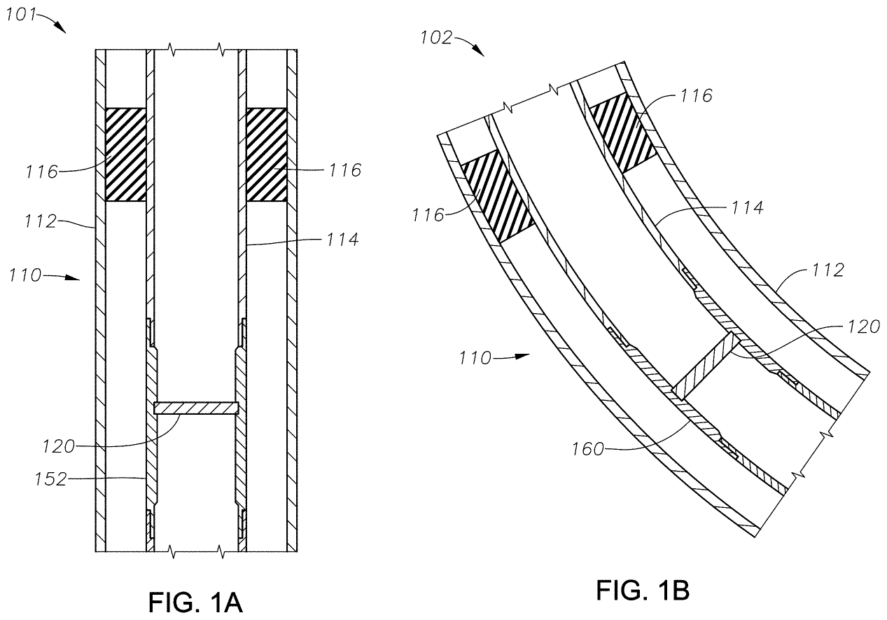

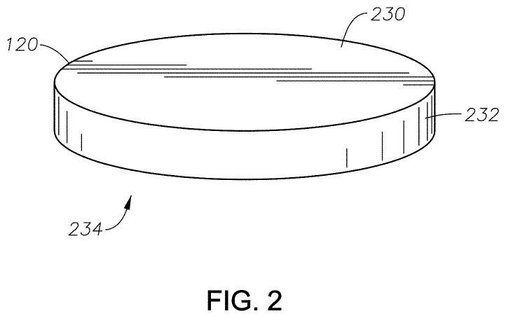

In the accompanying Figures, similar components or features, or both, can have a similar reference label. For the purpose of the simplified schematic illustrations and descriptions of FIGS. 1A through 2, the numerous temperature and pressure sensors, controllers, and the like that can be employed and well known to those of ordinary skill in the art are not included. Further, accompanying components that are in conventional industrial operations are not depicted. However, operational components, such as those described in the present disclosure, can be added to the embodiments described in this disclosure.

### DETAILED DESCRIPTION

While the disclosure will be described with several embodiments, it is understood that one of ordinary skill in the relevant art will appreciate that many examples, variations and alterations to the systems and methods described are within the scope and spirit of the disclosure. Accordingly, the embodiments of the disclosure described are set forth without any loss of generality, and without imposing limitations, on the claims.

Advantageously, the present disclosure allows for preparation of the wellbore for production by disabling a degradable downhole disk without downhole intervention resulting in substantial cost, time, and efficiency savings. Disabling or breaching the degradable disk downhole without downhole tool runs also prevents potential complications from raising and lowing tools. Reducing the number of downhole tools and trips used is a vital advantage as it reduces the chances of tools get stuck downhole, damage to the wellbore, or damage to the tools. Since downhole milling tools require physical contact, they are more likely to experience problems downhole such as damage, interference from debris, or other mechanical failure than non-contact intervention such as the present system and method disclosed herein. Additionally, the degradable disk is disabled without intervention either from the surface, such as injection of compounds or intentionally increasing or decreasing pressure within the wellbore, or downhole intervention, such as tool lowering or injection of materials through coiled tubing. Additional advantages of the present disclosure include a non-contact physical breakdown of the degradable disk, long-distance intervention and breaching of the degradable disk, elimination of heavy downhole milling tools, a significant period of time between installation and breakdown, and excellent strength properties. Additionally, a portion of the material of the degradable disk can be plant-based.

The degradable disk is made of a material that allows for superb strength while breaking down over a period of time in the wellbore. The degradable disk material is a nanocomposite material, which includes a polymer binder and cellulose nano-fibers In some embodiments, the polymer binder is made of an environmentally degradable disposable material including a hydroxycarboxylic acid-containing polymer as described in U.S. Pat. No. 6,323,307, which is incorporated herein by reference in its entirety. The hydroxycarboxylic acid-containing polymer is a polymer that contains at least one type of hydroxycarboxylic acid, and may contain other materials. The hydroxycarboxylic acid includes all of its derivatives that can form polyester linkages in whole or in part, such as esters, salts, and amides of the same. Preferred hydroxycarboxylic acids of the present invention are α-hydroxycarboxylic acids, but other hydroxycarboxylic acids in which the hydroxyl group is attached to a different carbon, such as, but not limited to, the beta-, gamma-, delta-, epsilon-, and/or omega-carbon, can also be used. Suitable α-hydroxycarboxylic acids include lactic acid, glycolic acid, tartaric acid, malic acid, mandelic acid, benzylic acid, hydroxyl-valeric acid, 1-hydroxy-1-cyclo-hexane carboxylic acid, 2-hydroxy-2-(2-tetrahydrofuranyl) ethanoic acid, 2-hydroxy-2-(2-furanyl) ethanoic acid, 2-hydroxy-2-phenylpropionic acid, 2-hydroxy-2-methylpropionic acid, 2-hydroxy-2-methyl-butanoic acid, 2-hydroxy-2-ethylhexylcarboxylic acid, α-hydroxybutyric acid, α-hydroxyisobutyric acid, α-hydroxy-pentanoic acid, α-hydroxyhexanoic acid, α-hydroxyheptanoic acid, α-hydroxyoctanoic acid, α-hydroxynonanoic acid, α-hydroxydecanoic acid, α-hydroxydodecanoic acid, α-hydroxypentanoic acid, α-hydroxypalmitic acid, α-hydroxystearic acid, α-hydroxyarachidic acid, α-hydroxybehenic acid, α-hydroxylignoceric acid, α-hydroxycerotic acid, α-hydroxyoleic acid, α-hydroxylinoleic acid, α-hydroxylinolenic acid, α-hydroxyarachidonic acid, other α-hydroxycarboxylic acids having a carbon chain with an even number of carbon atoms, and mixtures of the same. Also suitable are α-hydroxycarboxylic acids with a carbon chain containing an odd number of carbon atoms. Examples include α-hydroxypelargonic acid, α-hydroxyundecanonic acid, α-hydroxytridecanoic acid, α-hydroxypentadecanonic acid, α-hydroxyheptadecanoic acid, and α-hydroxynonadecanoic acid. Preferred α-hydroxycarboxylic acids include lactic acid, glycolic acid, tartaric acid, malic acid, mandelic acid, benzylic acid, valeric acid, α-hydroxybutyric acid, α-hydroxyoctanoic acid, α-hydroxystearic acid, and mixtures of the same. Other α-hydroxycarboxylic acids include lactic acid, glycolic acid, and mixtures of the same. Other embodiments include lactones, such as caprolactone, aliphatic esters of glycols and dicarboxylic acids, and mixtures of the same.

The hydroxycarboxylic acid-containing polymer can be generated from polymerization of hydroxycarboxylic acid, at least one type of cyclic ester of at least one hydroxycarboxylic acid, at least one type of polymer block including an oligomer block containing at least one type of hydroxycarboxylic acid or cyclic ester, and other mixtures. Polymers of the present invention can include copolymers of hydroxycarboxylic acid, cyclic esters, oligomers, or mixtures of the same. Water is directly responsible for the hydrolysis of hydroxycarboxylic acid-containing polymers, and can be used as a preferred activator compound for the degradation as water is present in wellbore fluids.

The degradable disk is made of nanocomposite material that contains cellulose nano-fibers. These cellulose nano-fibers are fibers containing cellulose that are on a nano-scale in diameter or length. The cellulose nano-fibers can be derived from plant-based biomass materials, such as wood cellulose. In some embodiments, the cellulose nano-fibers are derived from wood pump that has been micro-refined to the nano-level, in the range of several hundredths of a micron and smaller. Suitable manufactures of cellulose nano-fibers include American Process Inc., Asahi Kasei, Borregaard, Chuetsu Pulp & Paper, Daicel, Daiichi Kogyo, Daio Paper, Imerys, and Innventia AB. Typically, shorter strands within materials demonstrate less strength; however, in this case, the short nano-scale fibers provide greater strength to the final material, making the material stronger than steel before degradation begins. The nanocomposite material is formed by compressing the polymer with the cellulose nano-fibers under high pressure.

The degradable disk nanocomposite material has features of high strength and high stiffness. The degradable disk is high strength with a tensile strength of about 30,000 psi. The tensile modulus of the material is approximately 24 Gpa. The degradable disk has a high stiffness around 3,000,000 psi. The strength to weight ratio of the degradable disk is 8 times that of stainless steel. Importantly, the nanocomposite material of the degradable disk can maintain its strength and durability within the wellbore over a period of time before degradation, without losing strength and withstanding the high temperatures and high pressures of the wellbore environment, so that downhole procedures requiring wellbore isolation can be performed safely.

Once installed, the degradable disk is exposed to the wellbore environment. The wellbore environment can have a pH of greater than or equal to 6, and a temperature up to 600° C. In some embodiments, the wellbore environment has a basic pH greater than 8. In other embodiments, the disk can endure wellbore environments with low pH less than 6. The wellbore environment includes a wellbore fluid which contains a solvent. In some preferred embodiments, the solvent is or contains water. In other embodiments, the solvent is a component in the wellbore fluid such as oil. When the solvent contacts the degradable disk, the degradable disk begins to degrade. The degradation occurs without the addition of materials or chemicals to the wellbore. The degradation occurs in the absence of any downhole tools or manual intervention.

The degradable disk degrades over a period of time while maintaining its strength until it degrades until a point of structural failure, depending upon the wellbore conditions and the specifications of the degradable disk, including the diameter and thickness. As the surface area of the disk increases, the degradation rate also increases. The degradable disk degrades over a period of time greater than 48 hours. Alternately, the degradable disk degrades over a period greater than 72 hours. In some embodiments, the degradable disk degrades over a period of 5 days to 30 days, alternately 7 days to 28 days, alternately 16 days to 26 days, alternately 7 days to 21 days, and alternately 14 days to 21 days. In some embodiments, the period of time is approximately 21 days. During this period of time, the degradable disk maintains pressure in the wellbore until structural failure occurs, resulting in a breach of the degradable disk. Advantageously, this long period of time allows for other preparations for the wellbore and wellbore procedures to be performed, such as packer installation, with a significant safety buffer. After the period of time, the degradable disk degrades to the point of structural failure and breach, and the degradable disk fails allowing the flowback of the well.

Referring to FIG. 1A, vertical wellbore portion 101 is depicted. Wellbore 110 includes production casing 112 and production tubing 114. In some embodiments, wellbore 110 is part of a shallow well. In some embodiments, wellbore 110 extends into a high-temperature formation (not pictured). Installed in the annulus between production casing 112 and production tubing 114 are packers 116. Optional nipple 152 is installed within production tubing 114. Nipple 152 can be a component of a drillstring, or a portion of a pipe in which a disk is installed either during pre-production piping installation or post-production piping installation. Nipple 152 is a completion component that provides a sealing area and optionally a locking profile. Nipple 152 can be a landing nipples, and can include a sealing area with a locking profile that locks degradable disk 120 into place.

Installed within production tubing 114 is degradable disk 120. Degradable disk 120 can be installed by methods known in the art, including installation during production tubing installation. The installation of degradable disk 120 can be significantly simplified as compared to other zonal isolation tools, as it requires limited installation equipment. Degradable disk 120 can be installed using conventional tools including wireline and slickline tools. Degradable disk 120 can be installed before production tubing 114 is installed into wellbore 110. Degradable disk 120 is capable of maintaining pressure in production tubing 114 while the wellbore procedure or other wellbore operations are being performed. The wellbore procedure can include the installation of packers 116, or other procedures requiring wellbore isolation. Degradable disk 120 can withstand and maintain wellbore pressure from 10 psi to 30,000 psi, and wellbore temperatures from 50° F. to 550° F. In some embodiments, degradable disk 120 is a primary pressure control, and back pressure valves (not pictured) are also installed within production tubing 114 as a secondary pressure control. In preferred embodiments, no additional plugs, plug seats, or other pressure control devices are used in wellbore 110. As degradable disk 120 degrades over a period of time, degradable disk 120 will eventually fail and fluids from below degradable disk 120 will flow through wellbore 110 and production tubing 114 to the surface (not pictured).

Referring to FIG. 1B, horizontal wellbore portion 102 is depicted, and shares many of the same elements and characteristics of vertical wellbore portion 101. Wellbore 110 contains horizontal wellbore portion 102. Disk sub 160 is installed in wellbore 110. Disk sub 160 is an optional component. Disk sub 160 can be a component of a drillstring, or can be incorporated directly within the piping in which a disk is installed either during pre-production piping installation or during post-production piping installation. Degradable disk 120 is installed within disk sub 160, either before production tubing 114 is installed in wellbore 110 or after production tubing 114 is installed in wellbore 110.

Referring to FIG. 2, degradable disk 120 is depicted. Degradable disk 120 is a flat, plate-like disk with top side 230, which is generally flat, and which can face either uphole (towards the surface, not pictured) or downhole (towards the formation, not pictured). Degradable disk 120 also has a bottom side 234, which is generally flat, positioned parallel to top side 230 and the same size as top side 230. Both top side 230 and bottom side 234 are flat. Flat edge 232 extends around degradable disk 120 and connects top side 230 and bottom side 234. When placed within the wellbore, flat edge 232 abuts the production tubing. In a preferred embodiment, the cross section of degradable disk 120 is a rectangular prism, and the disk is entirely flat. No cavities are included degradable disk 120. Cavities include divots, grooves, depressions, holes, apertures, and the like. Degradable disk 120 is made of a single homogenous nanocomposite material, and is a solid disk. Degradable disk 120 is not a largely concave disk or a largely convex disk. Neither top side 230 nor bottom side 234 are curved, convex, or concave. There is no outer protective layer or other coating on degradable disk 120. The size of degradable disk 120, including the diameter of top side 230 and bottom side 234, can be determined based upon the size of the wellbore or production tubing.

Ranges may be expressed throughout as from about one particular value, or to about another particular value. When such a range is expressed, it is to be understood that another embodiment is from the one particular value or to the other particular value, along with all combinations within said range.

The singular forms “a,” “an,” and “the” include plural referents, unless the context clearly dictates otherwise.

Optional or optionally means that the subsequently described event or circumstances can or may not occur. The description includes instances where the event or circumstance occurs and instances where it does not occur.

As used in the specification and in the appended claims, the words “has,” “contains,” and “include” and all grammatical variations thereof are each intended to have an open, non-limiting meaning that does not exclude additional elements or steps.

What is claimed is:

1. A method of preparing a wellbore for production by installing a degradable disk in the wellbore and subsequently breaching the degradable disk, the degradable disk operable to maintain pressure within the wellbore during a wellbore procedure, the method comprising the steps of:
exposing the degradable disk to a wellbore environment within the wellbore over an extended period of time, wherein the wellbore environment comprises a solvent;
allowing the degradable disk to degrade such that the degradable disk is unable to hold pressure within the wellbore resulting in a breach; and
further wherein the degradable disk comprises a nanocomposite material, the nanocomposite material comprising a polymer binder and cellulose nano-fibers.

2. The method of claim 1, wherein the degradable disk can withstand a wellbore pressure of 30,000 psi.

3. The method of claim 1, wherein the breach occurs at least 48 hours past installation of the degradable disk.

4. The method of claim 1, wherein the extended period of time the degradable disk degrades within the wellbore is in the range of 16 to 26 days.

5. The method of claim 1, wherein the breach of the degradable disk occurs in an absence of intervention.

6. A system for preparing a wellbore for production by installing a degradable disk in the wellbore and subsequently breaching the degradable disk, the system comprising:
the wellbore extending into a hydrocarbon reservoir; and
the degradable disk installed within the wellbore, the degradable disk operable to maintain pressure during a wellbore procedure for an extended period of time and comprising a nanocomposite material, the nanocomposite material comprising a polymer binder and cellulose nano-fibers.

7. The system of claim 6, wherein the degradable disk degrades over the extended period of time within the wellbore, wherein the degradation results in a breach of the degradable disk.

8. The system of claim 7, wherein the extended period of time is in the range of 16 to 26 days.

9. The system of claim 6, wherein the degradable disk can withstand a wellbore pressure of 30,000 psi.

10. A degradable downhole article for use in preparing a wellbore for production, the degradable downhole article comprising:
a flat circular disk, the flat circular disk having
a flat top;
a flat bottom, the flat top and the flat bottom positioned parallel and directly opposite one another;
a flat edge, the flat edge abutted perpendicular to both the flat top and the flat bottom
wherein the flat circular disk consists essentially of one solid piece in the absence of any open cavities;
wherein the flat circular disk is operable to be installed within a production tubing of the wellbore such that the flat circular disk tightly abuts an inner wall of the production tubing generating a seal and is operable to hold pressure within the wellbore; and
further wherein the flat circular disk comprises a nanocomposite material, the nanocomposite material comprising a polymer binder and cellulose nano-fibers, the nanocomposite material operable to degrade over an extended period of time such that at the end of the extended period of time, the flat circular disk is no longer able to hold pressure within the wellbore and experiences a breach.

11. The degradable downhole article of claim 10, wherein the extended period of time is in the range of 16 to 26 days.

12. The degradable downhole article of claim 10, wherein the degradable downhole article can withstand a wellbore pressure of 30,000 psi.
